(19) United States
(12) Patent Application Publication
(10) Pub. No.: US 2026/0205256 A1
(43) Pub. Date: Jul. 16, 2026

(54) RADIO-FREQUENCY DATA SYNCHRONIZATION METHOD AND APPARATUS, AND ELECTRONIC DEVICE AND READABLE STORAGE MEDIUM

(71) Applicant: SANECHIPS TECHNOLOGY CO., LTD., Shenzhen, Guangdong (CN)

(72) Inventors: Jialin REN, Shenzhen, Guangdong (CN); Hongyi XU, Shenzhen, Guangdong (CN); Yaoyu CHEN, Shenzhen, Guangdong (CN); Jikui ZHAO, Shenzhen, Guangdong (CN)

(21) Appl. No.: 19/135,698

(22) PCT Filed: Nov. 14, 2023
(86) PCT No.: PCT/CN2023/131381

§ 371 Date: Jun. 4, 2025

(30) Foreign Application Priority Data
Dec. 30, 2022 (CN) 202211720467.4

(51) Int. Cl. H04L 7/06; H04L 7/04

(52) U.S. Cl. CPC H04L 7/06; H04L 7/041

(57) ABSTRACT

The present disclosure discloses a radio-frequency data synchronization method and apparatus, an electronic device, and a computer-readable storage medium. The radio-frequency data synchronization method includes: acquiring a synchronization signal generated by an off-chip reference source, and sampling the synchronization signal based on a high-frequency clock signal to obtain a sampled synchronization signal; performing frequency division on the high-frequency clock signal to obtain first frequency-divided clock signals; performing, based on the sampled synchronization signal, phase synchronization on each of the first frequency-divided clock signals to obtain first synchronized frequency-divided clock signals; sampling, respectively based on each of the first synchronized frequency-divided clock signals, the sampled synchronization signal to obtain first frequency-divided sampled synchronization signals; and synchronizing, based on each of the first synchronized frequency-divided clock signals and each of the first frequency-divided sampled synchronization signals, radio-frequency-channel data flowing through a data converter in each of radio frequency transmission channels.

### CROSS REFERENCE TO RELATED APPLICATIONS

The present disclosure is a National Phase Application filed under 35 U.S.C. 371 as a national stage of PCT/CN2023/131381, filed on Nov. 14, 2023, an application claiming the priority to Chinese Patent Application No. 202211720467.4 filed on Dec. 30, 2022, the contents of which are incorporated herein by reference in their entirety.

### TECHNICAL FIELD

The present disclosure relates to the field of communication technology, and in particular, to a radio-frequency data synchronization method, a radio-frequency data synchronization apparatus, an electronic device, and a computer-readable storage medium.

### BACKGROUND

Beamforming is a technology for adaptively adjusting radiation of an antenna array according to a specific scene. Specifically, a base station adopts a plurality of antennas for transmission and reception, and a radiation direction of each antenna can be automatically adjusted to finally form superposition at a receiving point of a user, so that a signal strength of a signal at the receiving point of the user can be increased. The beamforming is to superpose signals at an air interface of a multiple-input multiple-output apparatus to complete concentrated emission of energy, so that the beamforming technology and the multiple-input multiple-output technology complement each other to improve communication quality together. However, signals from a plurality of channels are often not synchronous when being transmitted from an antenna end, such that signal strengths of signals received at a receiving end are low, and positioning accuracy and a communication distance are lost, resulting in degradation of performance of a multi-user multiple-input multiple-output apparatus.

### SUMMARY

The present disclosure provides a radio-frequency data synchronization method, including: acquiring a synchronization signal generated by an off-chip reference source, and sampling the synchronization signal based on a high-frequency clock signal to obtain a sampled synchronization signal; performing frequency division on the high-frequency clock signal to obtain first frequency-divided clock signals; performing, based on the sampled synchronization signal, phase synchronization on each of the first frequency-divided clock signals to obtain first synchronized frequency-divided clock signals; sampling, respectively based on each of the first synchronized frequency-divided clock signals, the sampled synchronization signal to obtain first frequency-divided sampled synchronization signals; and synchronizing, based on each of the first synchronized frequency-divided clock signals and each of the first frequency-divided sampled synchronization signals, radio-frequency-channel data flowing through a data converter in each of radio frequency transmission channels.

The present disclosure further provides a radio-frequency data synchronization apparatus, including: a high-frequency sampling module configured to acquire a synchronization signal generated by an off-chip reference source, and sample the synchronization signal based on a high-frequency clock signal to obtain a sampled synchronization signal; a clock frequency-division module configured to perform frequency division on the high-frequency clock signal to obtain first frequency-divided clock signals; a phase synchronization module configured to perform, based on the sampled synchronization signal, phase synchronization on each of the first frequency-divided clock signals to obtain first synchronized frequency-divided clock signals; a frequency-division sampling module configured to sample, respectively based on each of the first synchronized frequency-divided clock signals, the sampled synchronization signal to obtain first frequency-divided sampled synchronization signals; and a synchronization module configured to synchronize, based on each of the first synchronized frequency-divided clock signals and each of the first frequency-divided sampled synchronization signals, radio-frequency-channel data flowing through a data converter in each of radio frequency transmission channels.

The present disclosure further provides an electronic device, including: at least one processor, and a storage device in communication connection with the at least one processor, the storage device stores computer instructions executable by the at least one processor, and when the computer instructions are executed by the at least one processor, the at least one processor performs the above radio-frequency data synchronization method.

The present disclosure further provides a computer-readable storage medium having stored thereon a computer program for implementing a radio-frequency data synchronization method, and when the computer program for implementing the radio-frequency data synchronization method is executed by a processor, the processor performs the above radio-frequency data synchronization method.

### BRIEF DESCRIPTION OF DRAWINGS

The drawings here are incorporated into the specification and constitute a part of the specification. The drawings illustrate the implementations of the present disclosure, and are used to explain, together with the specification, the principle of the present disclosure.

In order to explain the technical solutions in the implementations of the present disclosure or the technical solutions in the existing technology more clearly, the drawings for the description of the implementations or the existing technology will be briefly described below. Apparently, other drawings can be derived by those of ordinary skill in the art from the drawings described herein without any inventive work.

FIG. 1 is a flowchart illustrating a radio-frequency data synchronization method according to an embodiment of the present disclosure;

FIG. 2 is a schematic diagram illustrating synchronization network in a radio-frequency data synchronization method according to an embodiment of the present disclosure;

FIG. 3 is another flowchart illustrating a radio-frequency data synchronization method according to an embodiment of the present disclosure;

FIG. 4 is a schematic diagram illustrating compensation for radio frequency transmitting channels in a radio-frequency data synchronization method according to an embodiment of the present disclosure;

FIG. 5 is another flowchart illustrating a radio-frequency data synchronization method according to an embodiment of the present disclosure;

FIG. 6 is a schematic diagram illustrating synchronization of reception of radio-frequency data in radio frequency receiving channels in a radio-frequency data synchronization method according to an embodiment of the present disclosure; and

FIG. 7 is a schematic structural diagram of a device of a hardware operating environment related to a radio-frequency data synchronization method according to an embodiment of the present disclosure.

The implementation, functional features, and advantages of the present disclosure will be further described in conjunction with specific implementations and with reference to the drawings.

### DETAIL DESCRIPTION OF EMBODIMENTS

In order to make the above objectives, features and advantages of the present disclosure more obvious and understandable, the technical solutions of the embodiments of the present disclosure are clearly and thoroughly described below in conjunction with the drawings for the embodiments of the present disclosure. Apparently, the implementations described herein are merely some implementations of the present disclosure, and do not cover all implementations. All other embodiments derived by those of ordinary skill in the art from the implementations described in the present disclosure without any inventive work fall within the scope of the present disclosure.

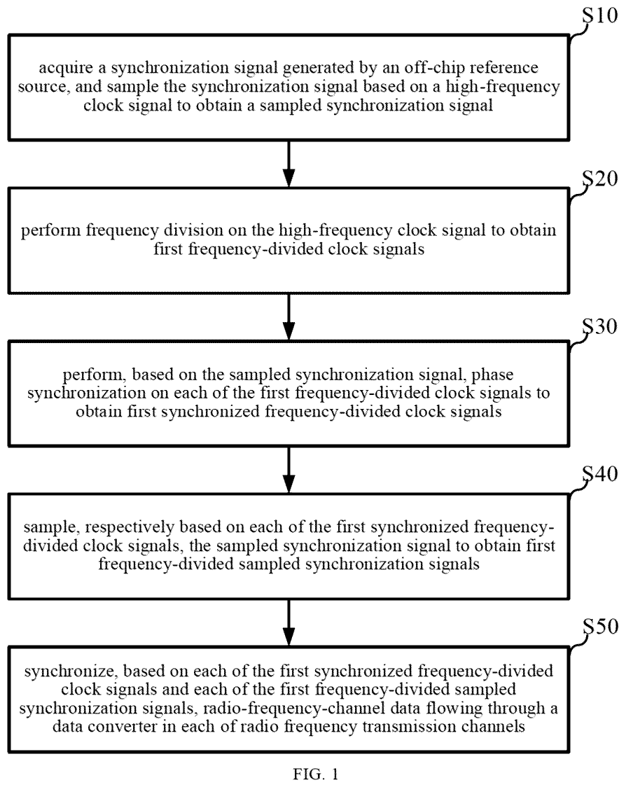

Referring to FIG. 1, an embodiment of the present disclosure provides a radio-frequency data synchronization method. In an implementation of the radio-frequency data synchronization method of the present disclosure, the radio-frequency data synchronization method includes the following operations S10 to S50.

At operation S10, acquiring a synchronization signal generated by an off-chip reference source, and sampling the synchronization signal based on a high-frequency clock signal to obtain a sampled synchronization signal.

At operation S20, performing frequency division on the high-frequency clock signal to obtain first frequency-divided clock signals.

At operation S30, performing, based on the sampled synchronization signal, phase synchronization on each of the first frequency-divided clock signals to obtain first synchronized frequency-divided clock signals.

At operation S40, sampling, respectively based on each of the first synchronized frequency-divided clock signals, the sampled synchronization signal to obtain first frequency-divided sampled synchronization signals.

At operation S50, synchronizing, based on each of the first synchronized frequency-divided clock signals and each of the first frequency-divided sampled synchronization signals, radio-frequency-channel data flowing through a data converter in each of radio frequency transmission channels.

In some implementations, operations S10 to S50 include: acquiring a synchronization signal generated by an off-chip reference source, and sampling the synchronization signal based on a high-frequency clock signal to obtain a sampled synchronization signal; according to a clock frequency needed by each of radio frequency transmission channels in a multiple-input multiple-output apparatus, performing frequency division on the high-frequency clock signal to obtain first frequency-divided clock signals; performing phase synchronization on each of the first frequency-divided clock signals by aligning each of the first frequency-divided clock signals with a frame header of the sampled synchronization signal to obtain first synchronized frequency-divided clock signals; sampling, respectively based on each of the first synchronized frequency-divided clock signals, the sampled synchronization signal to obtain first frequency-divided sampled synchronization signals; sending each of the first synchronized frequency-divided clock signals and each of the first frequency-divided sampled synchronization signals to a corresponding radio frequency transmission channel; and synchronizing, based on each of the first synchronized frequency-divided clock signals and each of the first frequency-divided sampled synchronization signals, radio-frequency-channel data flowing through a data converter in each of the radio frequency transmission channels, where the data converter is at least one of a digital-to-analog converter or an analog-to-digital converter. For a whole radio frequency transmission process, a synchronization process of each of the first frequency-divided clock signals is definite, so that synchronization precision of each of the first synchronized frequency-divided clock signals can be ensured; each of the first frequency-divided sampled synchronization signals is obtained by sampling the sampled synchronization signal respectively based on each of the first synchronized frequency-divided clocks, so that synchronization precision of each of the first frequency-divided sampled synchronization signals can also be ensured. Although the synchronization signal generated by the off-chip reference source and the high-frequency clock signal are asynchronous, there is at most one clock uncertainty when sampling the synchronization signal generated by the off-chip reference source based on the high-frequency clock signal, which may not result in a large precision deviation. Therefore, synchronization precision of multi-channel signals at a transmitting end and a receiving end can be improved, signal strengths of signals received by the receiving end can be increased, positioning precision and a communication distance can be increased, and performance of a multi-user multiple-input multiple-output apparatus can be improved.

In some implementations, the data converter may be at least one of a digital-to-analog converter or an analog-to-digital converter, and the radio frequency transmission channel may be at least one of a radio frequency receiving channel or a radio frequency transmitting channel.

Synchronizing, based on each of the first synchronized frequency-divided clock signals and each of the first frequency-divided sampled synchronization signals, the radio-frequency-channel data flowing through the data converter in each of the radio frequency transmission channels (i.e., operation S50) includes the following operations S51 to S54.

At operation S51, performing secondary frequency division on the first synchronized frequency-divided clock signal transmitted in each of the radio frequency transmission channels respectively to obtain a second frequency-divided clock signal in each of the radio frequency transmission channels.

At operation S52, performing, respectively based on each of the first frequency-divided sampled synchronization signals, phase synchronization on the second frequency-divided clock signal in each of the radio frequency transmission channels to obtain a second synchronized frequency-divided clock signal in each of the radio frequency transmission channels.

At operation S53, sampling, respectively based on each of the second synchronized frequency-divided clock signals, the first frequency-divided sampled synchronization signal in each of the radio frequency transmission channels to obtain a second frequency-divided sampled synchronization signal in each of the radio frequency transmission channels.

At operation S54, synchronizing, under each of the second synchronized frequency-divided clock signals, the radio-frequency-channel data flowing through each of the data converters by controlling a delay duration of the corresponding second frequency-divided sampled synchronization signal in each of the radio frequency transmission channels.

It should be noted that “under each of the second synchronized frequency-divided clock signals” in the present disclosure refers to taking “each of the second synchronized frequency-divided clock signals” as an operating clock for subsequent operations.

In some implementations, operations S51 to S54 include: according to the clock frequency needed by each of the radio frequency transmission channels, performing secondary frequency division on the first synchronized frequency-divided clock signal transmitted in each of the radio frequency transmission channels respectively to obtain a second frequency-divided clock signal in each of the radio frequency transmission channels; respectively performing phase synchronization on the second frequency-divided clock signal in each of the radio frequency transmission channels by respectively aligning the second frequency-divided clock signal in each of the radio frequency transmission channels with a frame header of a corresponding first frequency-divided sampled synchronization signal to obtain a second synchronized frequency-divided clock signal in each of the radio frequency transmission channels; sampling, respectively based on each of the second synchronized frequency-divided clock signals, the first frequency-divided sampled synchronization signal in each of the radio frequency transmission channels to obtain a second frequency-divided sampled synchronization signal in each of the radio frequency transmission channels; and synchronizing, under each of the second synchronized frequency-divided clock signals, the radio-frequency-channel data flowing through each of the data converters by controlling a delay duration of the corresponding second frequency-divided sampled synchronization signal in each of the radio frequency transmission channels, where the second frequency-divided sampled synchronization signal is configured to control a time point when radio-frequency data flows through the data converter.

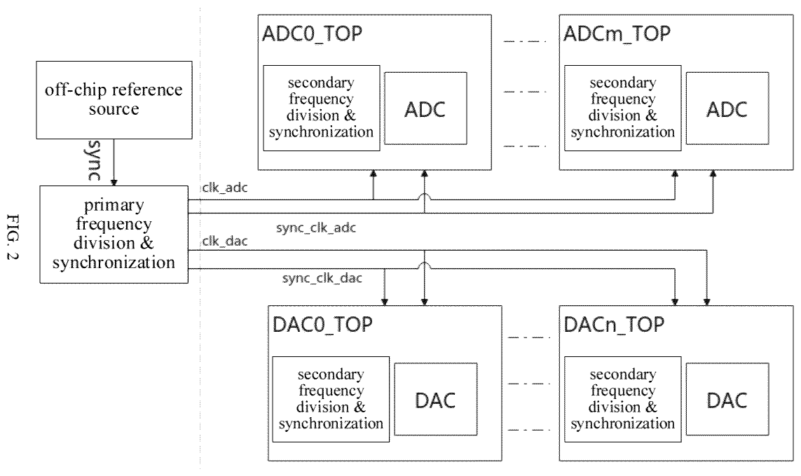

In some implementations, referring to FIG. 2 which is a schematic diagram illustrating synchronization network in a radio-frequency data synchronization method according to an embodiment of the present disclosure, a specific synchronization process is as follows: an off-chip reference source generates a unified synchronization signal sync for a chip; the synchronization signal is subjected to sampling and synchronization based on an on-chip high-frequency clock signal to obtain a sampled synchronization signalphases of primary frequency-divided clocks (i.e., the first frequency-divided clock signals) are synchronized with the sampled synchronization signal to obtain the first synchronized frequency-divided clock signals, and the sampled synchronization signal is sampled with the first synchronized frequency-divided clock signals to obtain the first frequency-divided sampled synchronization signals. In radio frequency receiving channels, the first synchronized frequency-divided clock signals clk_adc and the first frequency-divided sampled synchronization signals sync_clk_adc sent to analog-to-digital converters (ADCs) have two functions: one is for synchronous reception of a plurality of ADCs, and the other is for secondary frequency division within the ADCs according to requirements of the ADCs; and in radio frequency transmitting channels, the first synchronized frequency-divided clock signals clk_dac and the first frequency-divided sampled synchronization signals sync_clk_dac sent to digital-to-analog converters (DACs) have two functions: one is for processing for synchronous transmitting by multiple antennas, and the other is for secondary frequency division within the DACs according to requirements of the DACs. In this way, all the synchronization signals for digital-to-analog conversion are from the off-chip reference source, merely the synchronization signal input by the off-chip reference source and the high-frequency clock signal are asynchronous in the synchronization process of the whole network, the other clock frequency division and synchronization processes are definite, there is at most one clock uncertainty when sampling the synchronization signal sync based on the high-frequency clock signal during the primary frequency division process, and there is no uncertain factors in the subsequent secondary clock frequency divisions and synchronization processes, so that synchronization precision of radio-frequency data can be improved.

The embodiment of the present disclosure provides a radio-frequency data synchronization method including acquiring a synchronization signal generated by an off-chip reference source, and sampling the synchronization signal based on a high-frequency clock signal to obtain a sampled synchronization signal; performing frequency division on the high-frequency clock signal to obtain first frequency-divided clock signals; performing, based on the sampled synchronization signal, phase synchronization on each of the first frequency-divided clock signals to obtain first synchronized frequency-divided clock signals; sampling, respectively based on each of the first synchronized frequency-divided clock signals, the sampled synchronization signal to obtain first frequency-divided sampled synchronization signals; and synchronizing, based on each of the first synchronized frequency-divided clock signals and each of the first frequency-divided sampled synchronization signals, radio-frequency-channel data flowing through a data converter in each of radio frequency transmission channels. The synchronization signals for all the data converters are from the off-chip reference source, and during the whole radio-frequency data synchronization process, merely the high-frequency clock signal and the synchronization signal generated by the off-chip reference source are asynchronous, the other clock frequency division and synchronization processes are definite, and there is at most one clock uncertainty when sampling the synchronization signal generated by the off-chip reference source based on the high-frequency clock signal. Thus, the synchronization precision of the multi-channel signals at the transmitting end and the receiving end can be improved, the signal strengths of the signals received by the receiving end can be increased, the positioning precision and the communication distance can be increased, and the performance of the multi-user multiple-input multiple-output apparatus can be improved.

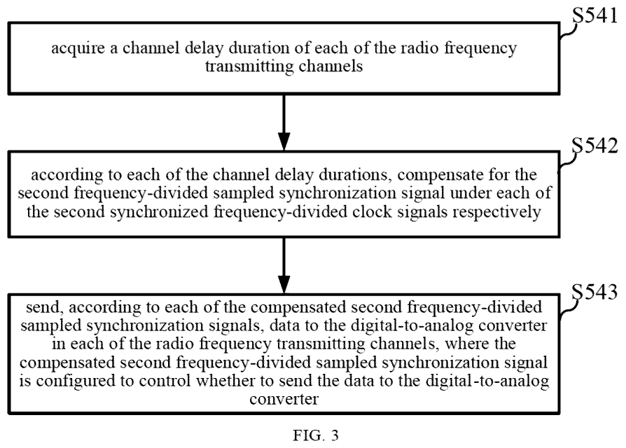

Further, referring to FIG. 3, the contents in the embodiment of the present disclosure which are the same as or similar to those of the above implementations may be found in the above description, and will not be repeated below. The radio frequency transmission channels include radio frequency transmitting channels, the data converters include digital-to-analog converters, and synchronizing, under each of the second synchronized frequency-divided clock signals, the radio-frequency-channel data flowing through each of the data converters by controlling the delay duration of the corresponding second frequency-divided sampled synchronization signal in each of the radio frequency transmission channels (i.e., operation S54) includes the following operations S541 to S543.

At operation S541, acquiring a channel delay duration of each of the radio frequency transmitting channels.

At operation S542, according to each of the channel delay durations, compensating for the second frequency-divided sampled synchronization signal under each of the second synchronized frequency-divided clock signals respectively.

At operation S543, sending, according to each of the compensated second frequency-divided sampled synchronization signals, data to the digital-to-analog converter in each of the radio frequency transmitting channels, where the compensated second frequency-divided sampled synchronization signal is configured to control whether to send the data to the digital-to-analog converter.

In the radio-frequency data synchronization method provided in the present disclosure, it should be noted that due to differences in hardware in the different radio frequency transmitting channels, the channel delay durations of the radio frequency transmitting channels are different when transmitting the radio-frequency data, resulting in de-synchronization of the data sent in the radio frequency transmitting channels.

In some implementations, operations S541 to S543 include: acquiring a channel delay duration of each of the radio frequency transmitting channels; according to deviations between the channel delay durations, compensating for the second frequency-divided sampled synchronization signal under each of the second synchronized frequency-divided clock signals with corresponding delay compensation value respectively; and sending, according to each of the compensated second frequency-divided sampled synchronization signals, data to the digital-to-analog converter in each of the radio frequency transmitting channels, where the compensated second frequency-divided sampled synchronization signal is configured to control whether to send the data to the digital-to-analog converter.

In some implementations, the second frequency-divided sampled synchronization signal may be a level signal, and when the second frequency-divided sampled synchronization signal is changed from a low level to a high level, start to control the data to be sent to the digital-to-analog converter, and a frame header signal of the second frequency-divided sampled synchronization signals is one-frame signal changed from the low level to the high level.

According to each of the channel delay durations, compensating for the second frequency-divided sampled synchronization signal under each of the second synchronized frequency-divided clock signals respectively (i.e., operation S542) includes the following operations A10 and A20.

At operation A10, determining, according to a deviation between the channel delay durations of the radio frequency transmitting channels, a delay compensation value corresponding to each of the radio frequency transmitting channels.

At operation A20, according to each of the delay compensation values, performing delay compensation on the second frequency-divided sampled synchronization signal under each of the second synchronized frequency-divided clock signals respectively.

In some implementations, operations A10 and A20 include: determining a maximum channel delay duration among the channel delay durations of the radio frequency transmitting channels, and respectively calculating a deviation between each of the other channel delay durations and the maximum channel delay duration to obtain delay deviations; according to each of the delay deviations, determining the delay compensation value corresponding to each of the radio frequency transmitting channels; and according to each of the delay compensation values, performing delay compensation on the second frequency-divided sampled synchronization signal under each of the second synchronized frequency-divided clock signals respectively. In this way, delay can be applied to the synchronized second frequency-divided sampled synchronization signal under each of the second synchronized frequency-divided clock signals, and since the compensated second frequency-divided sampled synchronization signal is configured to control whether to send the data to the digital-to-analog converter, a delay duration of each of the compensated second frequency-divided sampled synchronization signals superposed with the channel delay duration of the corresponding radio frequency transmitting channel can make overall delay durations of the radio frequency transmitting channels equal, so that a purpose of eliminating deviations between the overall delay durations of the different radio frequency transmitting channels can be realized, and the radio-frequency data sent in the radio frequency transmitting channels can be synchronized.

In some implementations, determining, according to each of the delay deviations, the delay compensation value corresponding to each of the radio frequency transmitting channels (i.e., operation A10) includes: acquiring a basic delay compensation value for the radio frequency channel corresponding to the maximum channel delay duration, and taking the basic delay compensation value as a delay compensation value corresponding to the maximum channel delay duration; and calculating the sum of each of the delay deviations and the basic delay compensation value respectively to obtain the delay compensation value corresponding to each of the other channel delay durations. For example, assuming that the basic delay compensation value is 0 ms and the delay deviations are respectively 1 ms and 2 ms, the delay compensation values corresponding to the other channel delay durations are respectively 1 ms and 2 ms; and assuming that the basic delay compensation value is 1 ms and the delay deviations are respectively 1 ms and 2 ms, the delay compensation values corresponding to the other channel delay durations are respectively 2 ms and 3 ms.

Sending, according to each of the compensated second frequency-divided sampled synchronization signals, the data to the digital-to-analog converter in each of the radio frequency transmitting channels (i.e., operation S543) includes the following operations B10 and B20.

At operation B10, detecting the compensated second frequency-divided sampled synchronization signal in each of the radio frequency transmitting channels respectively.

At operation B20, sending, if the compensated second frequency-divided sampled synchronization signal is detected as a preset trigger level signal, the data to the digital-to-analog converter in the radio frequency transmitting channel.

In some implementations, operations B10 and B20 include: detecting the compensated second frequency-divided sampled synchronization signal in each of the radio frequency transmitting channels respectively; and if the compensated second frequency-divided sampled synchronization signal is detected as a frame header signal, triggering sending the data to the digital-to-analog converter in the radio frequency transmitting channel, where the frame header signal is a one-frame signal in the second frequency-divided sampled synchronization signal which is changed from a low level to a high level.

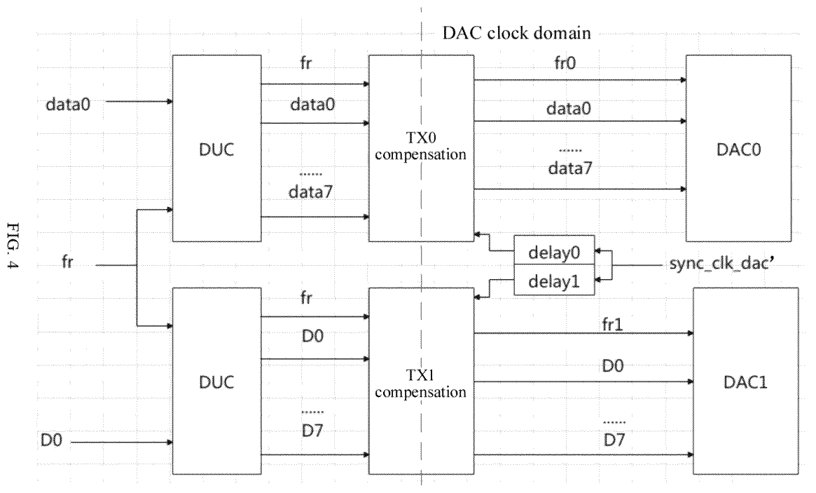

In some implementations, referring to FIG. 4 which is a schematic diagram illustrating compensation for radio frequency transmitting channels according to an embodiment of the present disclosure, DUC is a radio frequency digital terminal, TX0 compensation and TX1 compensation are caches in different radio frequency transmission channels, DAC0 and DAC1 are digital-to-analog converters in the different radio frequency transmission channels, fr, data0 . . . data7 denote radio-frequency data transmitted in a first radio frequency transmitting channel, fr, D0 . . . D7 denote radio-frequency data transmitted in a second radio frequency transmitting channel, sync_clk_dac′ denotes the second frequency-divided sampled synchronization signals in the radio frequency transmitting channels, delay0 denotes a delay compensation value for the first radio frequency transmitting channel, and delay1 denotes a delay compensation value for the second radio frequency transmitting channel. In the compensation process of the radio frequency transmitting channels illustrated by FIG. 4, multi-channel radio-frequency data sent by a multi-user multiple-input multiple-output apparatus to the DUCs are aligned, and the multi-channel radio-frequency data are output by the DACs after being processed, and are sent from antennas after being transmitted by radio frequency front ends. Due to differences between the front ends of the transmitting channels, the multi-channel radio-frequency data take different time along paths from the DACs to the antennas, and compensation for deviations between the different time is needed. For the processed radio-frequency data transmitted to the radio frequency front ends, compensation for the deviations between the different time taken from the radio frequency front ends to the antennas is performed first with the synchronization signals and the time compensation value corresponding to each of the transmitting channels, and then the compensated radio-frequency data are transmitted to the DACs, thus the compensated multi-channel DAC output data is simultaneously sent from the array antennas.

The embodiment of the present disclosure provides the radio-frequency data synchronization method applied to the radio frequency transmitting channels, that is, the channel delay duration of each of the radio frequency transmitting channels is acquired; according to each of the channel delay durations, the second frequency-divided sampled synchronization signal is respectively compensated for under each of the second synchronized frequency-divided clock signals; and according to each of the compensated second frequency-divided sampled synchronization signals, the data is sent to the digital-to-analog converter in each of the radio frequency transmitting channels, where the compensated second frequency-divided sampled synchronization signal is configured to control whether to send the data to the digital-to-analog converter. Thus, based on the channel delay duration of each of the radio frequency transmitting channels, the corresponding channel delay duration can be configured for each of the radio frequency transmitting channels. Since the second frequency-divided sampled synchronization signal is configured to control whether to send the data to the digital-to-analog converter, before sending the radio-frequency data to the DACs, the channel delay duration applied to the second frequency-divided sampled synchronization signal can compensate for the deviation between the different time taken from the radio frequency front ends to the antennas, so that the compensated multi-channel DAC output data can be simultaneously sent from the array antennas, and a purpose of synchronizing the radio-frequency data sent in the multiple radio frequency transmitting channels is realized. Therefore, the signal strengths of the signals received by the receiving end can be increased, the positioning precision and the communication distance can be increased, and the performance of the multi-user multiple-input multiple-output apparatus can be improved.

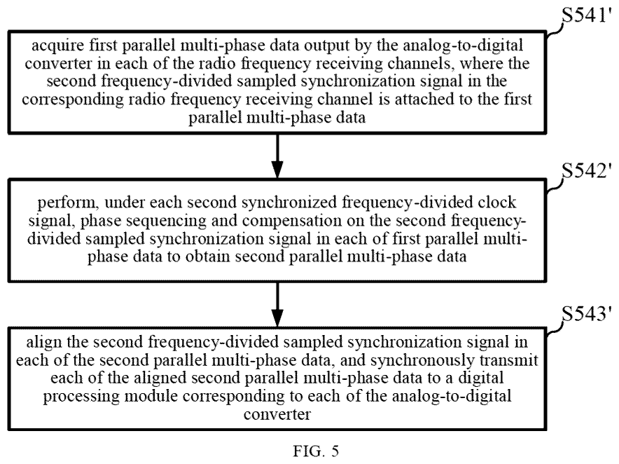

Further, referring to FIG. 5, the contents in the embodiment of the present disclosure which are the same as or similar to those of the above implementations may be found in the above description, and will not be repeated below. The radio frequency transmission channels include radio frequency receiving channels, the data converters include analog-to-digital converters, and synchronizing, under each of the second synchronized frequency-divided clock signals, the radio-frequency-channel data flowing through each of the data converters by controlling the delay duration of the corresponding second frequency-divided sampled synchronization signal in each of the radio frequency transmission channels (i.e., operation S54) includes the following operations S541′ to S543′.

At operation S541′, acquiring first parallel multi-phase data output by the analog-to-digital converter in each of the radio frequency receiving channels, where the second frequency-divided sampled synchronization signal in the corresponding radio frequency receiving channel is attached to the first parallel multi-phase data.

At operation S542′, performing, under each of the second synchronized frequency-divided clock signals, phase sequencing and compensation on the second frequency-divided sampled synchronization signal in each of the first parallel multi-phase data to obtain second parallel multi-phase data.

At operation S543′, aligning the second frequency-divided sampled synchronization signal in each of the second parallel multi-phase data, and synchronously transmitting each of the aligned second parallel multi-phase data to a digital processing module corresponding to each of the analog-to-digital converters.

In the radio-frequency data synchronization method provided in the present disclosure, it should be noted that the radio-frequency data is generally sent in parallel as multi-phase data in order to improve transmission efficiency of the radio-frequency data, so the radio-frequency data output by the analog-to-digital converters is generally multi-phase data.

In some implementations, operations S541′ to S543′ include: acquiring first parallel multi-phase data output by the analog-to-digital converter in each of the radio frequency receiving channels, where the second frequency-divided sampled synchronization signal in the corresponding radio frequency receiving channel is attached to the first parallel multi-phase data; under each of the second synchronized frequency-divided clock signals, respectively arranging the second frequency-divided sampled synchronization signal in each of the first parallel multi-phase data to a first phase to perform phase sequencing and compensation on the second frequency-divided sampled synchronization signal in each of the first parallel multi-phase data, so as to obtain second parallel multi-phase data; and aligning the second frequency-divided sampled synchronization signal in each of the second parallel multi-phase data by caching each of the second parallel multi-phase data, and synchronously transmitting each of the aligned second parallel multi-phase data to the digital processing module corresponding to each of the analog-to-digital converters.

Performing, under each of the second synchronized frequency-divided clock signals, phase sequencing and compensation on the second frequency-divided sampled synchronization signal in each of the first parallel multi-phase data to obtain second parallel multi-phase data (i.e., operation S542′) includes the following operation C10.

At operation C10, arranging, under each of the second synchronized frequency-divided clock signals, a phase where the second frequency-divided sampled synchronization signal in each of the first parallel multi-phase data to a first phase respectively.

In the radio-frequency data synchronization method provided in the present disclosure, it should be noted that, by arranging the phase where the second frequency-divided sampled synchronization signal in the parallel multi-phase data to the first phase, each of the arranged parallel multi-phase data may not be aligned, that is, a time when each of the parallel multi-phase data reaches the digital processing module corresponding to the analog-to-digital converter is not aligned.

In some implementations, operation C10 includes: receiving, by a register of each of the radio frequency receiving channels, the first parallel multi-phase data of the corresponding radio frequency receiving channel; and in each of the registers, arranging the phase where the second frequency-divided sampled synchronization signal in the first parallel multi-phase data under each of the second synchronized frequency-divided clock signals to the first phase respectively.

Aligning the second frequency-divided sampled synchronization signal in each of the second parallel multi-phase data, and synchronously transmitting each of the aligned second parallel multi-phase data to a digital processing module corresponding to each of the analog-to-digital converters (i.e., operation S543′) includes the following operations D10 to D30.

At operation D10, receiving and caching each of the second parallel multi-phase data by a preset cache module.

At operation D20, detecting whether the second frequency-divided sampled synchronization signal in each of the second parallel multi-phase data is cached to a preset initial address, and determining, if the second frequency-divided sampled synchronization signal in each of the second parallel multi-phase data is cached to the preset initial address, that the second frequency-divided sampled synchronization signal in each of the second parallel multi-phase data is aligned.

At operation D30, according to each of the second frequency-divided sampled synchronization signals, synchronously reading each of the second parallel multi-phase data from the preset initial address to the digital processing module corresponding to each of the analog-to-digital converters respectively.

In the radio-frequency data synchronization method provided in the present disclosure, it should be noted that the preset cache module includes a preset cache in each of the radio frequency receiving channels.

In some implementations, operations D10 to D30 include: receiving each of the second parallel multi-phase data by a preset cache in each of the radio frequency receiving channel respectively; caching each of the second parallel multi-phase data to a preset initial address in the corresponding preset cache respectively, detecting whether the second frequency-divided sampled synchronization signal in each of the second parallel multi-phase data is cached to the preset initial address, determining, if the second frequency-divided sampled synchronization signal in each of the second parallel multi-phase data is not cached to the preset initial address, that the second frequency-divided sampled synchronization signal in each of the second parallel multi-phase data is not aligned, and determining, if the second frequency-divided sampled synchronization signal in each of the second parallel multi-phase data is cached to the preset initial address, that the second frequency-divided sampled synchronization signal in each of the second parallel multi-phase data is aligned; and according to each of the second frequency-divided sampled synchronization signals, synchronously reading each of the second parallel multi-phase data from the preset initial address to the digital processing module corresponding to each of the analog-to-digital converters respectively, where the second frequency-divided sampled synchronization signal is configured to whether to read the second parallel multi-phase data from the preset cache. Thus, by providing the registers and the preset caches between the analog-to-digital converters and the digital processing modules, the second frequency-divided sampled synchronization signal in each of the second parallel multi-phase data can be arranged to the first phase to be aligned and then sent to a next-stage data processing module, and the next-stage digital processing module can synchronously read each of the second parallel multi-phase data from each of the preset caches according to each of the second frequency-divided sampled synchronization signals arranged in the first phase, that is, synchronously receiving each of the second parallel multi-phase data, so that synchronization precision of receiving the radio-frequency data in each of the radio frequency receiving channels can be improved.

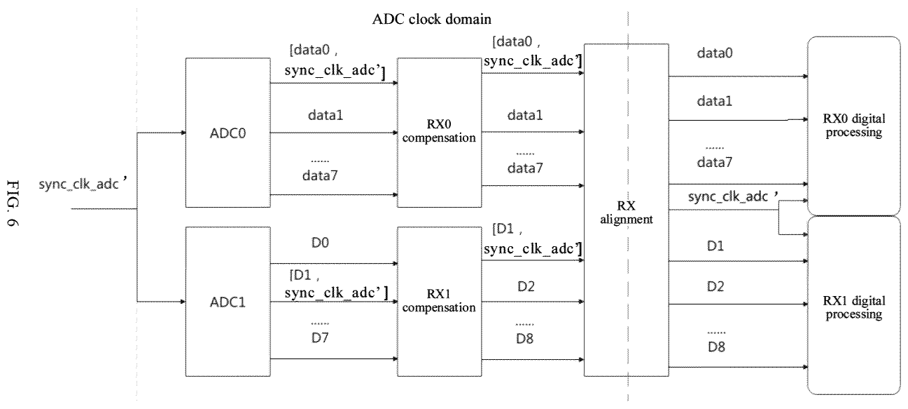

Referring to FIG. 6 which is a schematic diagram illustrating synchronization of reception of radio-frequency data in radio frequency receiving channels according to an embodiment of the present disclosure, ADC0 is an analog-to-digital converter in a first radio frequency receiving channel, ADC1 is an analog-to-digital converter in a second radio frequency receiving channel, data0, data1 . . . data7 denote parallel multi-phase data in the first radio frequency receiving channel, D0, D1 . . . D7 denote parallel multi-phase data in the second radio frequency receiving channel, sync_clk_adc′ denotes the second frequency-divided sampled synchronization signals in the radio frequency receiving channels, RX0 compensation and RX1 compensation may be registers, RX alignment may be a preset cache, and RX0 digital processing and RX1 digital processing are digital processing modules.

The embodiment of the present disclosure provides the radio-frequency data synchronization method applied to the radio frequency receiving channels, that is, the first parallel multi-phase data output by the analog-to-digital converter in each of the radio frequency receiving channels is acquired, where the second frequency-divided sampled synchronization signal in the corresponding radio frequency receiving channel is attached to the first parallel multi-phase data; under each of the second synchronized frequency-divided clock signals, phase sequencing and compensation is performed on the second frequency-divided sampled synchronization signal in each of the first parallel multi-phase data to obtain the second parallel multi-phase data; and the second frequency-divided sampled synchronization signal in each of the second parallel multi-phase data is aligned, and each of the aligned second parallel multi-phase data is synchronously transmitted to the digital processing module corresponding to each of the analog-to-digital converters. That is, by disposing the cache modules between the analog-to-digital converters and the digital processing modules and arranging, in the cache modules, the second frequency-divided sampled synchronization signals in the second parallel multi-phase data output by the analog-to-digital converters to the first phases to be aligned, the digital processing modules can synchronously read the second parallel multi-phase data from each of the preset caches based on each of the second frequency-divided sampled synchronization signals, thereby ensuring the synchronization of the radio-frequency data received in the radio frequency receiving channels. Therefore, the signal strengths of the signals received by the receiving end can be increased, the positioning precision and the communication distance can be increased, and the performance of the multi-user multiple-input multiple-output apparatus can be improved.

The present disclosure further provides a radio-frequency data synchronization apparatus, including: a high-frequency sampling module configured to acquire a synchronization signal generated by an off-chip reference source, and sample the synchronization signal based on a high-frequency clock signal to obtain a sampled synchronization signal; a clock frequency-division module configured to perform frequency division on the high-frequency clock signal to obtain first frequency-divided clock signals; a phase synchronization module configured to perform, based on the sampled synchronization signal, phase synchronization on each of the first frequency-divided clock signals to obtain first synchronized frequency-divided clock signals; a frequency-division sampling module configured to sample, respectively based on each of the first synchronized frequency-divided clock signals, the sampled synchronization signal to obtain first frequency-divided sampled synchronization signals; and a synchronization module configured to synchronize, based on each of the first synchronized frequency-divided clock signals and each of the first frequency-divided sampled synchronization signals, radio-frequency-channel data flowing through a data converter in each of radio frequency transmission channels.

In some implementations, the synchronization module is further configured to: perform secondary frequency division on the first synchronized frequency-divided clock signal transmitted in each of the radio frequency transmission channels respectively to obtain a second frequency-divided clock signal in each of the radio frequency transmission channels; perform, respectively based on each of the first frequency-divided sampled synchronization signals, phase synchronization on the second frequency-divided clock signal in each of the radio frequency transmission channels to obtain a second synchronized frequency-divided clock signal in each of the radio frequency transmission channels; sample, respectively based on each of the second synchronized frequency-divided clock signals, the first frequency-divided sampled synchronization signal in each of the radio frequency transmission channels to obtain a second frequency-divided sampled synchronization signal in each of the radio frequency transmission channels; and synchronize, under each of the second synchronized frequency-divided clock signals, the radio-frequency-channel data flowing through each of the data converters by controlling a delay duration of the corresponding second frequency-divided sampled synchronization signal in each of the radio frequency transmission channels.

In some implementations, the radio frequency transmission channels include radio frequency transmitting channels, the data converters include digital-to-analog converters, and the synchronization module is further configured to: acquire a channel delay duration of each of the radio frequency transmitting channels; compensate for the second frequency-divided sampled synchronization signal under each of the second synchronized frequency-divided clock signals respectively according to each of the channel delay durations; and send data to the digital-to-analog converter in each of the radio frequency transmitting channels according to each of the compensated second frequency-divided sampled synchronization signals, where the compensated second frequency-divided sampled synchronization signal is configured to control whether to send the data to the digital-to-analog converter.

In some implementations, the synchronization module is further configured to: determine a delay compensation value corresponding to each of the radio frequency transmitting channels according to a deviation between the channel delay durations of the radio frequency transmitting channels; and perform delay compensation on the second frequency-divided sampled synchronization signal under each of the second synchronized frequency-divided clock signals respectively according to each of the delay compensation values.

In some implementations, the synchronization module is further configured to: detect the compensated second frequency-divided sampled synchronization signal in each of the radio frequency transmitting channels respectively; and send, if the compensated second frequency-divided sampled synchronization signal is detected as a preset trigger level signal, the data to the digital-to-analog converter in the radio frequency transmitting channel.

In some implementations, the radio frequency transmission channels include radio frequency receiving channels, the data converters include analog-to-digital converters, and the synchronization module is further configured to: acquire first parallel multi-phase data output by the analog-to-digital converter in each of the radio frequency receiving channels, where the second frequency-divided sampled synchronization signal in the corresponding radio frequency receiving channel is attached to the first parallel multi-phase data; perform phase sequencing and compensation on the second frequency-divided sampled synchronization signal in each of the first parallel multi-phase data under each of the second synchronized frequency-divided clock signals to obtain second parallel multi-phase data; and align the second frequency-divided sampled synchronization signal in each of the second parallel multi-phase data, and synchronously transmit each of the aligned second parallel multi-phase data to a digital processing module corresponding to each of the analog-to-digital converters.

In some implementations, the synchronization module is further configured to: arrange, under each of the second synchronized frequency-divided clock signals, a phase where the second frequency-divided sampled synchronization signal in each of the first parallel multi-phase data to a first phase respectively.

In some implementations, the synchronization module is further configured to: receive and cache each of the second parallel multi-phase data by a preset cache module; detect whether the second frequency-divided sampled synchronization signal in each of the second parallel multi-phase data is cached to a preset initial address, and determine, if the second frequency-divided sampled synchronization signal in each of the second parallel multi-phase data is cached to the preset initial address, that the second frequency-divided sampled synchronization signal in each of the second parallel multi-phase data is aligned; and synchronously read, according to each of the second frequency-divided sampled synchronization signals, each of the second parallel multi-phase data from the preset initial address to the digital processing module corresponding to each of the analog-to-digital converters respectively.

The radio-frequency data synchronization apparatus provided in the present disclosure adopts the above radio-frequency data synchronization method, and solves the technical problem of the degradation of the performance of the multi-user multiple-input multiple-output apparatus caused by de-synchronization of signal transmitting at the antenna end. Compared with the existing technology, the beneficial effects of the radio-frequency data synchronization apparatus provided in the embodiment of the present disclosure are the same as those of the above radio-frequency data synchronization method, and other technical features of the radio-frequency data synchronization apparatus are the same as the above disclosed technical features of the radio-frequency data synchronization method, and thus will not be repeated here.

An embodiment of the present disclosure provides an electronic device, including: at least one processor, and a storage device in communication connection with the at least one processor; and the storage device stores computer instructions executable by the at least one processor, and when the computer instructions are executed by the at least one processor, the at least one processor performs the above radio-frequency data synchronization method.

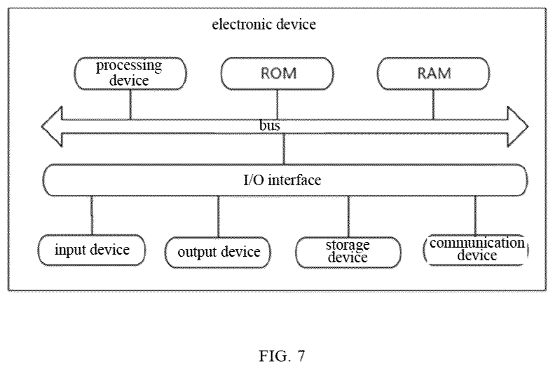

Referring to FIG. 7 which is a schematic structural diagram of an electronic device suitable to implement the embodiment of the present disclosure, the electronic device in the embodiment of the present disclosure may include, but is not limited to, a mobile terminal such as a mobile phone, a laptop, a digital broadcast receiver, a Personal Digital Assistant (PDA), a tablet personal computer (e.g., a PAD), a Portable Multimedia Player (PMP), and a vehicle-mounted terminal (e.g., a car navigation terminal) and a fixed terminal such as a digital TV and a desktop computer. The electronic device shown in FIG. 7 is merely an example, and does not constitute any limitation to functions and a scope of use of the embodiment of the present disclosure.

As shown in FIG. 7, the electronic device may include a processing device (e.g., a central processing unit and a graphic processing unit), and is capable of performing various appropriate actions and processing according to programs stored in a Read-Only Memory (ROM) or programs loaded from a storage device to a Random Access Memory (RAM). Various programs and data for the operation of the electronic device are also stored in the RAM. The processing device, the ROM, and the RAM are connected to each other through a bus. An input/output (I/O) interface is also connected to the bus.

In general, the devices which may be connected to the I/O interface are as follows: an input device such as a touch screen, a touch pad, a keyboard, a mouse, an image sensor, a microphone, an accelerometer, and a gyroscope; an output device such as a Liquid Crystal Display (LCD), a speaker, and a vibrator; a storage device such as a magnetic tape and a hard disk; and a communication device. The communication device may enable the electronic device to communicate with other devices in a wireless or wired way to exchange data. It should be understood that, although FIG. 7 shows the electronic device provided with various devices, it is not desired to implement or provide all the devices. More or fewer devices may be alternatively implemented or provided.

In particular, according to the embodiments of the present disclosure, the processes described above with reference to the flowcharts may be implemented as a computer software program. For example, an embodiment of the present disclosure includes a computer program product, including a computer program borne on a computer readable medium, and the computer program includes program codes configured to perform the method illustrated by the flowcharts. In such embodiment, the computer program may be downloaded from a network through a communication device and installed, or may be installed from a storage device, or may be installed from an ROM. When executed by a processing device, the computer program performs the functions defined above in the method according to the embodiments of the present disclosure.

The electronic device provided in the present disclosure adopts the above radio-frequency data synchronization method, and solves the technical problem of the degradation of the performance of the multi-user multiple-input multiple-output apparatus caused by the de-synchronization of signal transmitting at the antenna end. Compared with the existing technology, the beneficial effects of the electronic device provided in the embodiment of the present disclosure are the same as those of the above radio-frequency data synchronization method, and other technical features of the electronic device are the same as the above disclosed technical features of the radio-frequency data synchronization method, and thus will not be repeated here.

It should be understood that each part of the present disclosure may be implemented in hardware, software, firmware, or a combination thereof. In the description of the above implementations, the specific features, structures, materials or characteristics may be combined in any of at least one embodiment or example in an appropriate way

What is described above is merely the specific implementations of the present disclosure, but the scope of the present disclosure is not limited thereto. Those of ordinary skill in the art can easily envisage changes or substitutions within the technical scope disclosed by the present disclosure, and all those changes or substitutions should be considered to fall within the scope of the present disclosure. Therefore, the scope of the present disclosure should be subject to the scope of the claims.

The present disclosure provides a computer-readable storage medium having stored thereon computer-readable program instructions configured to perform the above radio-frequency data synchronization method.

The computer-readable storage medium provided in an embodiment of the present disclosure may be, for example, a USB flash disk, but is not limited to, an electronic apparatus or device, a magnetic apparatus or device, an optical apparatus or device, an electromagnetic apparatus or device, an infrared apparatus or device or a semiconductor apparatus or device, or any combination thereof. Specific examples of the computer-readable storage medium may include, but are not limited to, an electrical connector having at least one wire, a portable computer disk, a hard disk, an RAM, an ROM, an Erasable Programmable Read-Only Memory (EPROM), a flash memory, an optical fiber, a portable Compact Disc Read-Only Memory (CD-ROM), an optical storage device, a magnetic storage device, or any suitable combination thereof. In the present embodiment, the computer-readable storage medium may be any tangible medium that contains or stores a program capable of being used by or together with an instruction execution apparatus or device. Program codes contained in the computer-readable storage medium may be transferred with any proper medium that includes, but is not limited to, a wire, an optical fiber, a Radio Frequency (RF) medium, or any suitable combination thereof.

The computer-readable storage medium may be included in an electronic device, or may be independent of the electronic device, without being mounted to the electronic device.

The computer-readable storage medium carries at least one computer program which, when executed by an electronic device, causes the electronic device to: acquire a synchronization signal generated by an off-chip reference source, and sample the synchronization signal based on a high-frequency clock signal to obtain a sampled synchronization signal; perform frequency division on the high-frequency clock signal to obtain first frequency-divided clock signals; based on the sampled synchronization signal, perform phase synchronization on each of the first frequency-divided clock signals to obtain first synchronized frequency-divided clock signals; sample, respectively based on each of the first synchronized frequency-divided clock signals, the sampled synchronization signal to obtain first frequency-divided sampled synchronization signals; and synchronize, based on each of the first synchronized frequency-divided clock signals and each of the first frequency-divided sampled synchronization signals, radio-frequency-channel data flowing through a data converter in each of radio frequency transmission channels.

The computer program codes for implementing the present disclosure may be written in at least one programming language or a combination thereof, and the programming language includes an object-oriented programming language such as Java, Smalltalk, and C++, and also includes a conventional procedural programming language, such as C or similar programming languages. The program codes may be executed on a user's computer totally or partially, or executed as a stand-alone software package, or executed partially on the user's computer and partially on a remote computer, or executed totally on the remote computer or a remote server. In a case where the remote computer is involved, the remote computer may be connected to the user's computer through any type of networks, including a Local Area Network (LAN) or a Wide Area Network (WAN), or may be connected to an external computer (for example, through the Internet via an Internet service provider).

The flowcharts and the block diagrams in the drawings illustrate the possible architectures, functions, and operations of the apparatus, method and computer program product according to each embodiment of the present disclosure. Each block in the flowcharts or block diagrams may represent a module, a program segment or a part of codes, and the module, the program segment or the part of codes contains at least one executable instruction configured to implement a specified logical function. It should be further noted that the functions shown in the blocks may occur in orders different from those illustrated in the drawings in some alternative implementations. For example, two connected blocks may be substantially executed in parallel in fact, but sometimes the two connected blocks may be executed in a reverse order, depending on the involved functions. It should be further noted that each block in the block diagrams and/or flowcharts and combinations of the blocks in the block diagrams and/or flowcharts may be implemented by special-purpose hardware-based devices which perform specified functions or operations, or may be implemented by combinations of dedicated hardware and computer instructions.

The modules described in the embodiments of the present disclosure may be implemented by software or hardware. The names of the modules do not constitute any limitation to the modules themselves in some cases.

The computer-readable storage medium provided in the present disclosure stores the computer-readable program instructions configured to perform the above radio-frequency data synchronization method, and solves the technical problem of the degradation of the performance of the multi-user multiple-input multiple-output apparatus caused by the de-synchronization of signal transmitting at the antenna end. Compared with the existing technology, the beneficial effects of the computer-readable storage medium provided in the embodiment of the present disclosure are the same as those of the radio-frequency data synchronization method provided in the above embodiment of the present disclosure, and thus will not be repeated here.

What is described above is just some exemplary embodiments of the present disclosure, and is not intended to limit the scope of the present disclosure. All equivalent structures or equivalent flow transformations derived from the contents of the description and the drawings of the present disclosure or direct or indirect applications of the contents of the description and the drawings of the present disclosure to other related technical fields are included in the scope of the present disclosure.

What is claimed is:

1. A radio-frequency data synchronization method, comprising:
acquiring a synchronization signal generated by an off-chip reference source, and sampling the synchronization signal based on a high-frequency clock signal to obtain a sampled synchronization signal;
performing frequency division on the high-frequency clock signal to obtain first frequency-divided clock signals;
performing, based on the sampled synchronization signal, phase synchronization on each of the first frequency-divided clock signals to obtain first synchronized frequency-divided clock signals;
sampling, respectively based on each of the first synchronized frequency-divided clock signals, the sampled synchronization signal to obtain first frequency-divided sampled synchronization signals; and
synchronizing, based on each of the first synchronized frequency-divided clock signals and each of the first frequency-divided sampled synchronization signals, radio-frequency-channel data flowing through a data converter in each of radio frequency transmission channels.

2. The radio-frequency data synchronization method of claim 1, wherein synchronizing, based on each of the first synchronized frequency-divided clock signals and each of the first frequency-divided sampled synchronization signals, the radio-frequency-channel data flowing through the data converter in each of the radio frequency transmission channels comprises:
performing secondary frequency division on the first synchronized frequency-divided clock signal transmitted in each of the radio frequency transmission channels respectively to obtain a second frequency-divided clock signal in each of the radio frequency transmission channels;
performing, respectively based on each of the first frequency-divided sampled synchronization signals, phase synchronization on the second frequency-divided clock signal in each of the radio frequency transmission channels to obtain a second synchronized frequency-divided clock signal in each of the radio frequency transmission channels;
sampling, respectively based on each of the second synchronized frequency-divided clock signals, the first frequency-divided sampled synchronization signal in each of the radio frequency transmission channels to obtain a second frequency-divided sampled synchronization signal in each of the radio frequency transmission channels; and
synchronizing, under each of the second synchronized frequency-divided clock signals, the radio-frequency-channel data flowing through each of the data converters by controlling a delay duration of the corresponding second frequency-divided sampled synchronization signal in each of the radio frequency transmission channels.

3. The radio-frequency data synchronization method of claim 2, wherein the radio frequency transmission channels comprise radio frequency transmitting channels, the data converters comprise digital-to-analog converters, and synchronizing, under each of the second synchronized frequency-divided clock signals, the radio-frequency-channel data flowing through each of the data converters by controlling the delay duration of the corresponding second frequency-divided sampled synchronization signal in each of the radio frequency transmission channels comprises:
acquiring a channel delay duration of each of the radio frequency transmitting channels;
according to each of the channel delay durations, compensating for the second frequency-divided sampled synchronization signal under each of the second synchronized frequency-divided clock signals respectively; and
sending, according to each of the compensated second frequency-divided sampled synchronization signals, data to the digital-to-analog converter in each of the radio frequency transmitting channels, wherein the compensated second frequency-divided sampled synchronization signal is configured to control whether to send the data to the digital-to-analog converter.

4. The radio-frequency data synchronization method of claim 3, wherein according to each of the channel delay durations, compensating for the second frequency-divided sampled synchronization signal under each of the second synchronized frequency-divided clock signals respectively comprises:
determining, according to a deviation between the channel delay durations of the radio frequency transmitting channels, a delay compensation value corresponding to each of the radio frequency transmitting channels; and
according to each of the delay compensation values, performing delay compensation on the second frequency-divided sampled synchronization signal under each of the second synchronized frequency-divided clock signals respectively.

5. The radio-frequency data synchronization method of claim 3, wherein sending, according to each of the compensated second frequency-divided sampled synchronization signals, the data to the digital-to-analog converter in each of the radio frequency transmitting channels comprises:
detecting the compensated second frequency-divided sampled synchronization signal in each of the radio frequency transmitting channels respectively; and
sending, if the compensated second frequency-divided sampled synchronization signal is detected as a preset trigger level signal, the data to the digital-to-analog converter in the radio frequency transmitting channel.

6. The radio-frequency data synchronization method of claim 2, wherein the radio frequency transmission channels comprise radio frequency receiving channels, the data converters comprise analog-to-digital converters, and synchronizing, under each of the second synchronized frequency-divided clock signals, the radio-frequency-channel data flowing through each of the data converters by controlling the delay duration of the corresponding second frequency-divided sampled synchronization signal in each of the radio frequency transmission channels comprises:
acquiring first parallel multi-phase data output by the analog-to-digital converter in each of the radio frequency receiving channels, wherein the second frequency-divided sampled synchronization signal in the corresponding radio frequency receiving channel is attached to the first parallel multi-phase data;
performing, under each of the second synchronized frequency-divided clock signals, phase sequencing and compensation on the second frequency-divided sampled synchronization signal in each of the first parallel multi-phase data to obtain second parallel multi-phase data; and
aligning the second frequency-divided sampled synchronization signal in each of the second parallel multi-phase data, and synchronously transmitting each of the aligned second parallel multi-phase data to a digital processing module corresponding to each of the analog-to-digital converters.

7. The radio-frequency data synchronization method of claim 6, wherein performing, under each of the second synchronized frequency-divided clock signals, phase sequencing and compensation on the second frequency-divided sampled synchronization signal in each of the first parallel multi-phase data to obtain the second parallel multi-phase data comprises:
arranging, under each of the second synchronized frequency-divided clock signals, a phase where the second frequency-divided sampled synchronization signal in each of the first parallel multi-phase data to a first phase respectively.

8. The radio-frequency data synchronization method of claim 6, wherein aligning the second frequency-divided sampled synchronization signal in each of the second parallel multi-phase data, and synchronously transmitting each of the aligned second parallel multi-phase data to the digital processing module corresponding to each of the analog-to-digital converters comprises:
receiving and caching each of the second parallel multi-phase data by a preset cache module;
detecting whether the second frequency-divided sampled synchronization signal in each of the second parallel multi-phase data is cached to a preset initial address, and determining, if the second frequency-divided sampled synchronization signal in each of the second parallel multi-phase data is cached to the preset initial address, that the second frequency-divided sampled synchronization signal in each of the second parallel multi-phase data is aligned; and
according to each of the second frequency-divided sampled synchronization signals, synchronously reading each of the second parallel multi-phase data from the preset initial address to the digital processing module corresponding to each of the analog-to-digital converters respectively.

9. (canceled)

10. An electronic device, comprising:
at least one processor; and
a storage device in communication connection with the at least one processor, wherein
the storage device stores computer instructions executable by the at least one processor, and when the computer instructions are executed by the at least one processor, the at least one processor performs steps of:
acquiring a synchronization signal generated by an off-chip reference source, and sampling the synchronization signal based on a high-frequency clock signal to obtain a sampled synchronization signal;
performing frequency division on the high-frequency clock signal to obtain first frequency-divided clock signals;
performing, based on the sampled synchronization signal, phase synchronization on each of the first frequency-divided clock signals to obtain first synchronized frequency-divided clock signals;
sampling, respectively based on each of the first synchronized frequency-divided clock signals, the sampled synchronization signal to obtain first frequency-divided sampled synchronization signals; and
synchronizing, based on each of the first synchronized frequency-divided clock signals and each of the first frequency-divided sampled synchronization signals, radio-frequency-channel data flowing through a data converter in each of radio frequency transmission channels.

11. A non-transitory computer-readable storage medium having stored thereon a computer program for implementing a radio-frequency data synchronization method, when the computer program for implementing the radio-frequency data synchronization method is executed by a processor, the processor performs steps of:
acquiring a synchronization signal generated by an off-chip reference source, and sampling the synchronization signal based on a high-frequency clock signal to obtain a sampled synchronization signal;
performing frequency division on the high-frequency clock signal to obtain first frequency-divided clock signals;
performing, based on the sampled synchronization signal, phase synchronization on each of the first frequency-divided clock signals to obtain first synchronized frequency-divided clock signals;
sampling, respectively based on each of the first synchronized frequency-divided clock signals, the sampled synchronization signal to obtain first frequency-divided sampled synchronization signals; and
synchronizing, based on each of the first synchronized frequency-divided clock signals and each of the first frequency-divided sampled synchronization signals, radio-frequency-channel data flowing through a data converter in each of radio frequency transmission channels.
